(19) United States
(12) Patent Application Publication
(10) Pub. No.: US 2025/0308070 A1
(43) Pub. Date: Oct. 2, 2025

(54) CALIBRATING A CAMERA MOUNTED TO A VEHICLE

(71) Applicant: Raven Industries, Inc., Sioux Falls, SD (US)

(72) Inventors: Spyridon Evangelatos, Attiki (GR); Nikolaos C. Tsagkopoulos, Peristeri (GR); Aikaterini Karakoula, Athens (GR); Alexandros Emmanouill Nikolakakis, Attiki (GR)

(21) Appl. No.: 19/097,423

(22) Filed: Apr. 1, 2025

(30) Foreign Application Priority Data
Apr. 2, 2024 (GR) 20240100232

(51) Int. Cl. G06T 7/80; B60R 1/22; G06T 7/246

(52) U.S. Cl. CPC G06T 7/80; B60R 1/22; G06T 7/246; B60R 2300/302; B60Y 2200/221; G06T 2207/10016; G06T 2207/20048; G06T 2207/30252

(57) ABSTRACT

System and techniques for determining calibration parameters for a camera mounted to a vehicle are described herein. The system obtains images at multiple points in time that contain the same feature. The feature is simulated in a second image based on a representation of the feature in a first image. The difference between the simulated feature and a representation of the feature in the second image is iteratively minimized by adjusting the available calibration parameters.

### CLAIM OF PRIORITY

This patent application claims the benefit of priority, under 35 U.S.C. § 119, to Greek patent application No. 20240100232, titled “CALIBRATING A CAMERA MOUNTED TO A VEHICLE” and filed on Apr. 2, 2024, the entirety of which is hereby incorporated by reference herein.

### TECHNICAL FIELD

Embodiments described herein generally relate to vehicle control systems and more specifically to calibrating a camera mounted to a vehicle.

### BACKGROUND

A wide range of vehicles across various industries harness camera systems to facilitate a multitude of autonomous operations. These camera systems serve as sensory components, enabling vehicles to operate autonomously or semi-autonomously in numerous applications. Examples of such systems encompass not only the full automation of vehicles themselves but also the control or augmentation of systems being transported by these vehicles, leading to increased efficiency and precision in various tasks.

Calibrating sensors, particularly cameras, for vehicle use helps to ensure the accuracy of data produced by the sensors. Camera calibration often involves adjusting the camera's settings to accurately capture and interpret visual information, such as lane markings, traffic signs, obstacles, objects, etc. Calibration can include setting camera focus, alignment, or field of view, as well as compensating for lens distortions or ensuring color accuracy.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment including a system for calibrating a camera mounted to a vehicle, according to an embodiment.

FIG. 2 illustrates an example of a transformation between coordinate systems, according to an embodiment.

FIG. 3 illustrates an example of locating features from a two-dimensional representation to a three-dimensional model of an environment, according to an embodiment.

FIG. 4 illustrates an example of correspondence between two two-dimensional images of an environment, according to an embodiment.

FIG. 5 illustrates a flow diagram of an example of a method for calibrating a camera mounted to a vehicle, according to an embodiment.

FIG. 6 is a block diagram illustrating an example of a machine upon which one or more embodiments may be implemented.

### DETAILED DESCRIPTION

Camera calibration in vehicles typically involves one or more techniques. Examples of these techniques include geometric calibration and stereoscopic calibration. Geometric calibration aligns the camera perspective with vehicle geometry and the three-dimensional world they operates within. The process generally involves several operations. First, the camera is precisely positioned and oriented relative to known reference points on the vehicle. This helps to ensure an optimal alignment with the vehicle dimensions and operational parameters. For example, a rear-view camera is aligned to effectively capture the area behind the vehicle without blind spots to the extent possible. Then, the camera field of view can be adjusted to cover a defined spatial area around the vehicle, which may involve adjusting the camera lens to capture a wide view for backup purposes or a focused range for forward-facing cameras. Here, special calibration patterns or targets are often used, which the camera captures at known distances and angles to calibrate its spatial perception. This operation is often important for mapping two-dimensional (2D) image data into a three-dimensional (3D) context.

In vehicles with multiple cameras, geometric calibration also helps to ensure that all camera perspectives are harmonized, which is useful for a cohesive view of the surroundings, such as in a 360-degree camera system. After the physical adjustment of the camera or cameras on the vehicle, software can be used to fine-tune the calibration, correcting any minor misalignments to ensure consistency in images captured by the camera or cameras. Such adjustments can include aligning the images with a reference frame of the vehicle and real-world coordinates.

With respect to software techniques, Bundle Adjustment provides assistance in computer vision or photogrammetry problems. Bundle Adjustment is useful for reconstructing 3D environments from multiple images. However, it can also be applied to single camera calibration in vehicles, where it enables measurement, and thus refinement, of extrinsic parameters, such as position or orientation, of the camera. Bundle Adjustment generally involves capturing multiple images of the vehicle's surroundings, including various known landmarks or calibration patterns from different angles or distances. Key features (e.g., points) are identified within these images, which might be specific points on a calibration grid or distinct environmental features (e.g., identifiable pixels or patterns of pixels). An initial estimate of camera parameters can be made based on manufacturing specifications or previous calibrations. Bundle Adjustment then adjusts the camera parameters to minimize a re-projection error. The Re-projection error is a discrepancy between the observed feature positions in the images and the predicted positions based on the model (e.g., of the camera and the environment) and the camera parameters. This is an iterative optimization technique in which a parameter is changed-which changes the model—and the re-projection is performed. When the re-projection error is lowest, then the camera parameter is optimized. In general, Bundle Adjustment provides a robust and accurate technique for camera parameter discovery through the use of simultaneous camera parameter discovery, leading to precise calibrations.

Issues can arise from relying on geometric or software calibration alone. Often, for successful geometric calibration, a relatively controlled environment is needed, often, in a factory or well-equipped shop, in order to precisely place a camera. Software calibration, such as Bundle Adjustment, is often complex, to address a large number of calibration variables possible using only images produced by the camera. Although these techniques can be combined to increase accuracy, such combinations also involve additional complexity. The equipment complexity of geometric calibration and the computing complexity of software calibration can make it difficult to implement these techniques in the field or in a third party (e.g., addon) manner.

To address the issues above, a hybrid approach can be employed to reduce complexity in both geometric and software calibration of cameras on vehicles, such as tractors, operating in a partially controlled environment, such as a field of crops. A mounting device (e.g., bracket, holder, stand, etc.) can be configured to provide a rough geometric calibration of a camera with respect to the vehicle. The configuration can include a rigidity that, under normal operating circumstances, fixes the camera relative to the vehicle. This fixed relationship can provide both an initial orientation of the camera with respect to the vehicle and the environment of the vehicle as well as ensure that variations in images captured from the camera while the vehicle moves maintain a fixed relationship with the vehicle movement and the environment. Because the mounting device can include variation in mounting position on a vehicle as well as the camera, within a relatively small tolerance, software calibration can be used to measure the variation and provide a more accurate calibration of the camera orientation after the camera is mounted.

When using the mounting device, the software calibration can be simplified over traditional techniques because of the stable and fixed platform provided by the mounting device as well as the relatively controlled environment of the vehicle. For example, the initial estimate of camera orientation can be entered by a user in the field through measurement of the camera height above ground and values supplied by the mounting device (e.g., downward angle). Further, because the mounting device rigidly connects the camera to the vehicle, a transformation between vehicle coordinate frames can be used. Here, vehicle motion—for example taken from a satellite position device, vehicle control unit, external observation, etc.—can be used to perform this transformation, simplifying calculations. Further, in the context of a field or similar controlled environment, assumptions as to the flatness of the environmental context can be used to further simplify these calculations. As described below, this leads to a simplified parameter discovery technique than is available with traditional Bundle Adjustment approaches. This simplification enables the addition of cameras to vehicles with reduced equipment complexity than the traditional alternatives. Additional details and examples are provided below.

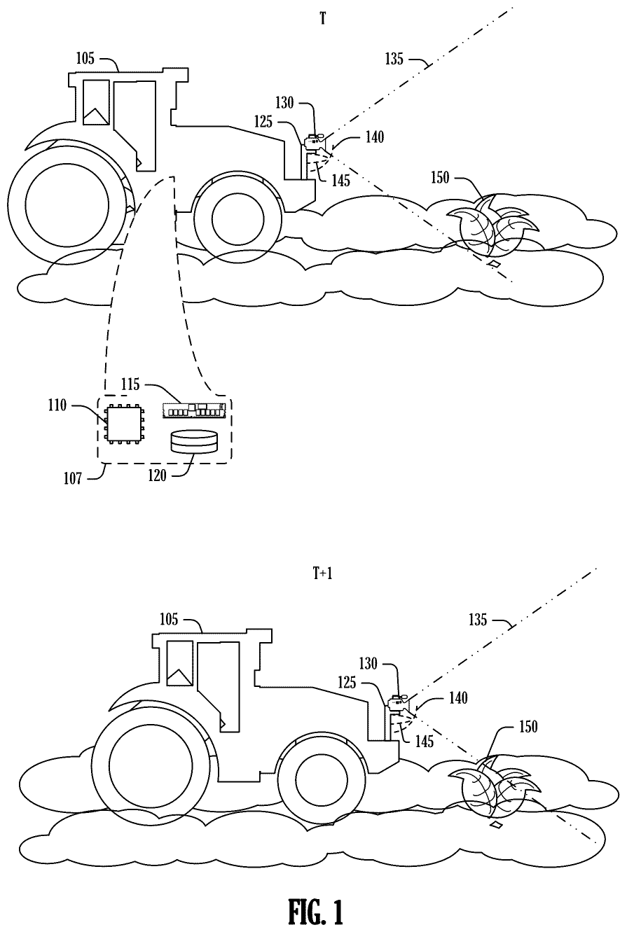

FIG. 1 is a block diagram of an example of an environment including a system 107 for calibrating a camera 130 mounted to a vehicle 105, according to an embodiment. As illustrated, the system 107 includes processing circuitry 110 (e.g., a processor, graphics processing unit (GPU), etc.), working memory 115 (e.g., volatile or non-volatile random access memory (RAM)), and storage 120 (e.g., non-volatile solid state storage, hard drive, optical drive, etc.). The working memory 115 is configured to hold state information of the system 107 while in operation and is usually reset (e.g., cleared) when power is interrupted or the system 107 is reset (e.g., rebooted). The storage 120 is configured to persist data or instructions between such power or reset events. The working memory 115 or the storage 120 can include (e.g., store) instructions that, when the processing circuitry 110 is operating, configure the processing circuitry to perform a variety of functions. The system 107 is illustrated as being part of (e.g., included in or installed in) the vehicle 105. However, in other configurations, the system 107 can be a standalone computing device, included in the camera 130, or included in the mounting device 125.

The mounting device 125 is configured to hold the camera 130 rigidly to the vehicle 105. As such, the mounting device 125 can be called a bracket, mount, frame, etc. The mounting device 125 is configured to be mounted on the vehicle and hold the camera 130 so as to provide a forward view to the camera 130. In an example, the mounting device 125 can be mounted on a roof of the vehicle 105. In an example, the mounting device 125 can be mounted on a hood or a bumper of the vehicle 105. Once mounted upon the vehicle 105, the mounting device 125 is configured to hold the camera 130 within a threshold of a fixed orientation. The orientation can include rotational components, including pitch 140, yaw 145, and roll (not shown). In an example, the mounting device 125 is configured to hold the camera 130 at a pitch down of angle of seventeen degrees. That is, the pitch 140 is negative seventeen degrees from the horizontal (e.g., the ground). In an example, the mounting device 125 is configured to hold the camera 130 at a yaw 145 or roll angle of zero degrees. In an example, the threshold (e.g., tolerance) of the mounting device 125 with respect to a rotational angle is plus or minus five degrees.

The camera 130 includes a field-of-view 135. When held by the mounting device 125 on the vehicle 105, the field-of-view 135 covers an area of the environment in a direction of travel of the vehicle 105. Generally, in a wheeled vehicle such as the illustrated tractor, the direction of travel is in front of the vehicle 105. In the context of component arrangements illustrated, the following examples illustrate the operation of the processing circuitry to perform a calibration of the camera 130 when mounted to the vehicle 105. As noted previously, the processing circuitry 110 can be hardwired, configured by software from the memory 115 or the storage 120 when in operation, or any combination of these elements to perform the following operations.

The processing circuitry 110 is configured to obtain (e.g., receive, retrieve, derive, etc.) an initial orientation of the camera 130 with respect to the vehicle 105. In an example, the initial orientation is based on the mounting device 125. In an example, the initial orientation is provided via a user interface. In this example, an operator can measure the height of the camera 130 above the ground and provide a model of the mounting device 125, or one or more rotational angles provided by markings on the mounting device 125 into the user interface. In an example, the mounting device 125 includes an interface (e.g., wired or wireless) that is configured to communicate a rotational angle, height above ground, or other aspect of the initial orientation of the camera 130 to the processing circuitry 110.

The processing circuitry 110 is configured to obtain a first image from the camera 130 at a first time (T). The top of FIG. 1 is marked T to illustrate this first time. Here, the first image includes a feature 150 of an environment. Although the feature 150 is illustrated as a plant, in general, such features are one or more (e.g., a pattern) of identifiable pixels in a raster image. Accordingly, a feature is anything that can be identified (e.g., distinguished) image from other parts of the image. Example feature detectors can include Oriented FAST and Rotated BRIEF (ORB), Scale Invariant Feature Transform (SIFT), or Speeded Up Robust Features (SURF).

The processing circuitry 110 is configured to obtain a second image from the camera 130 at a second time (T+1), illustrated on the bottom portion of FIG. 1. Here, the vehicle 105 has moved (e.g., driven) between the first time T and the second time T+1. This second image also includes the feature 150. In an example, movement of the vehicle 105 is based on following a calibration course. The calibration course includes features, such as turns, level ground, etc., that enable a more efficient calibration. In an example, the calibration course defines a progression of the vehicle 105 that includes movement in a straight line (e.g., within normal tolerance of operating the vehicle 105), a turnaround (e.g., a turn that ends with the vehicle 105 in an orientation that is 180 degrees from when the vehicle 105 started the turn), and moves back over the previously traversed path.

The processing circuitry 110 is configured to apply a transformation to the feature 150 in the first image to produce a simulated feature in the second image. This transformation is a predefined model based on a variety of factors, such as the environment, the camera 130, or an orientation of the camera 130. In an example, the transformation is based on motion of the vehicle 105. In an example, the motion of the vehicle 105 is based on a combination of a satellite positioning system and an inertial measurement unit that are both mounted on the vehicle 105.

The transformation is configured such that, if the parameters of the model match those of the environment, the simulated feature in the second image will match (e.g., within a threshold) the feature 150 as observed in the second image. When the simulated feature does not match the feature 150 in the second image, a parameter of the model is incorrect. The parameters of the model can then be adjusted, a new simulated feature produced, a variance between the new simulated feature and the feature 150 in the second image again can be compared. This iterative process can continue until the simulated feature matches the feature 150 in the second image. Thus, the processing circuitry 110 is configured to adjust an aspect of initial orientation of the camera 130 to minimize a distance between the simulated feature and the feature 150 in the second image. In an example, the aspect of the initial orientation that is adjust during this procedure limited to pitch 140 or yaw 145. Thus, roll is not adjusted.

In an example, adjusting the aspect of the initial orientation includes finding a local minimum as a version of the aspect. In an example, finding the local minima includes limiting a search of the local minima to plus or minus five degrees from the initial orientation. These examples take advantage of a processing efficiency enabled by the controlled environment present in several applications, such as within a warehouse or on an agricultural field. Generally, the application constrains a type of terrain (e.g., generally flat ground) and a type of movement (e.g., generally in straight or gradually curving lines with occasional turns for a brief reorientation of the vehicle 105). With the rigid mounting of the camera 130 to the vehicle, these conditions enable a simplification of more complex parameter discovery techniques. That is, the local minimum is the correct value and there is no concern that the local minimum is not the absolute minimum given the arrangement. In contrast, Bundle Adjustment, for example, does not have such assurances. Accordingly, the present arrangement reduces computational complexity while still resulting in determination of orientation aspects of the camera 130 that can be used to calibrate vision systems based on the camera 130.

In an example, the transformation simulates a ray (e.g., of light) being projected from the camera at the first time to the feature 150 in the environment and reprojected (e.g., projected, reflected, etc.) back to the camera at the second time to produce the simulated feature in the second image. This simulation can include a variety of techniques, such as ray-tracing used in image rendering. Another way to think about this procedure is the projection of the ray and a determination of where the ray intersects a given plane. Thus, the projection from one image to the ground plane has an intersection with the ground plane that indicates the position of the point in the 3D model; and a projection from this 3D model point to the second image provides the simulated point. Another technique that can be used alone or to supplement the projection technique is use of a homography that shifts the feature 150 in the first image to the simulated feature position without simulation. A homographic approach can take advantage of a relatively fixed environment, such as a tractor driving in a relatively flat field in a straight line, while a simulation approach can be more appropriate for less controlled, or more varied, environments.

The previous examples illustrated a simulation of the feature 150 from the first image onto the second image and the iterative procedure to ascertain orientation aspects of the camera 130 based on a deviation of the simulated feature from the representation of the feature 150 in the second image. Additional accuracy can also be obtained by a reverse procedure, whereby a second transformation is applied to the feature 150 detected in the second image to produce a second simulated feature on the first image. Again, as above, the distance between the second simulated feature and the feature 150 in the first image provides a measure of error in an orientation of the camera 130 that can be minimized.

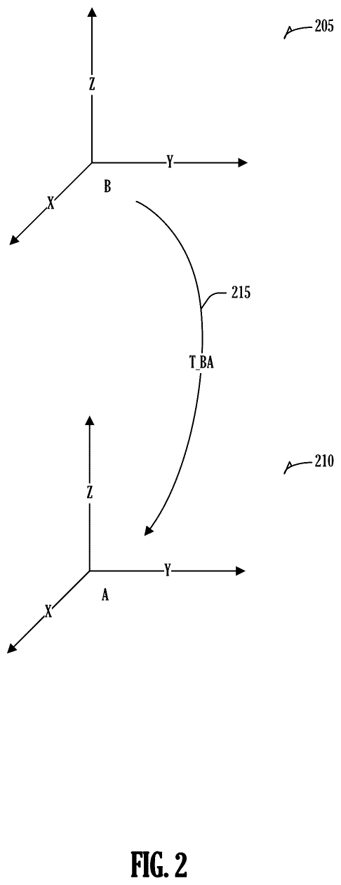

FIG. 2 illustrates an example of a transformation 205 between coordinate systems, according to an embodiment. As noted above, a transform is applied to a feature to produce a simulated feature. The illustrated transform 215 is more a more general concept of a procedure to translate from one coordinate system, such a coordinate system B 205 to a second coordinate system, such as coordinate system A 210. Accordingly, the transformation 215 is a transformation from the B coordinate system to the A coordinate system. Generally, in 3D space, the transformation 215 can be described by a four-by-four (e.g., 4×4) rotation and translation matrix (e.g., [R|t]) that relates the two coordinate frames together. With this transformation matrix, a 3D point from one coordinate system 205 can be transformed into a 3D point in other coordinate system of the transformation 215.

For example, given a 3D point in the B coordinate system 205 (e.g., frame B), the same 3D point can be expressed in the A coordinate system 210 using the operation:

$${p}_{B} = [ \begin{matrix} \\ {x}_{B} \\ {y}_{B} \\ {z}_{B} \\ 1\end{matrix} ] = {T}_{A}^{B} [ \begin{matrix}{x}_{Z} \\ {y}_{A} \\ {z}_{A} \\ 1\end{matrix} ]$$

where

$${T}_{A}^{B}$$

is the relative transformation 215 of B with respect to A. Also,

$${T}_{A}^{B} {T}_{B}^{A} = 1 and {T}_{A}^{{B}^{- 1}} = {T}_{B}^{A} .$$

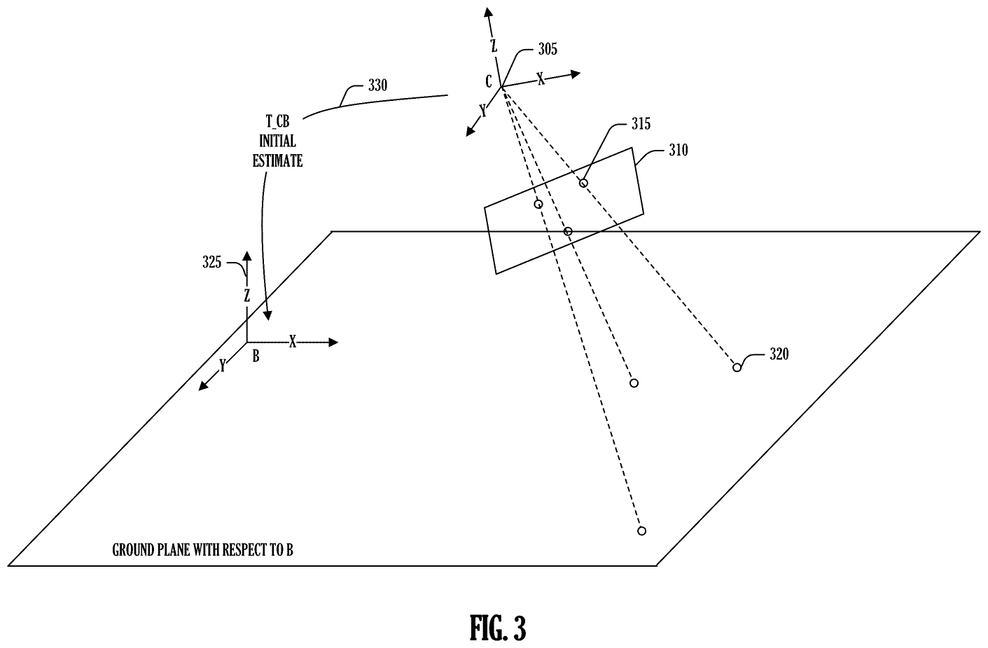

FIG. 3 illustrates an example of locating features from a two-dimensional representation 310 to a three-dimensional model of an environment, according to an embodiment. Consider the context of FIG. 1, in which a mounting device is installed on the top of the tractor to observe the area in front of the tractor. During camera calibration, the camera is assigned a coordinate frame (e.g., frame C 305) that is aligned with the camera sensor. There is also a tractor coordinate frame (e.g., frame B 325) whose X axis is parallel to the vehicle's axis of motion, Z axis is pointing towards the sky and origin is at the projection of the device on the ground level. In this scenario, to relate any points observed by the camera system to the tractor (e.g., and components or implements such as nozzles) and accurate determination of the transformation 330 between the camera frame C 305 and the tractor frame B 325.

In an example, an initial estimate these two coordinate frames (frame C 305 and frame B 325) can be obtained, by, for example, using the tractor's height and assuming that the mounting device is installed correctly (e.g., horizontally and looking directly forward). The transformation 330 is efficiently refined by taking advantage the rigidness of device mounting device because the transformation 330 remains constant over time (e.g., the relationship between the two frames does not change), and the knowledge of the trajectory of the tactor (e.g., the B frame 325) over time.

For the following example, the camera is frame C 305 and the tractorfilte is frame B 325. The frame B 325 can also be referred to as the base. Given the initial approximation for the camera to base transformation

$$330 {T}_{C}^{B} ,$$

and an assumption that the camera intrinsic values (e.g., lens alignment, focus, etc.,) are known (e.g., represented in a known intrinsic camera matrix K), an array <F1, F2, . . . , Fm=M>, of temporal features can be gathered. Here F is a TemporalFeatures object and M represents the total number of frames. The TemporalFeatures object can include the following fields (e.g., members):
.features1: 2D points detected in camera frame at

$$t - 1 , \begin{matrix}2 \times n \\ {o}_{t - 1}\end{matrix}$$

features2: 2D points detected in camera frame at t,

$$\begin{matrix}2 \times n \\ {o}_{t}\end{matrix}$$

reconstructions: 3D reconstructed points with respect to Bₜ₋₁,

$$\begin{matrix}3 \times n \\ r\end{matrix}$$

motion_transformation: The relative motion of the vehicle (e.g., frame B 325) between two consecutive timesteps, expressed in the base frame

$$\begin{matrix}4 \times 4 \\ {T}_{t - 1}^{t}\end{matrix} .$$

Not all fields of the TemporalFeatures need to be populated to begin with. For example, the reconstructions field can be populated following the data collection and application of the transformation 330. That is, for example, after data collection (e.g., images and features are acquired), 2D cross-correspondences can be reconstructed into 3D space. Thus, the 2D points 315 in the 2D image 310 are modeled to 3D points 320 in the environment model. In an example, the transformation 330 is a model that hold the ground plane constant (e.g., the model assumes ground planarity, or the ground equation is z=0).

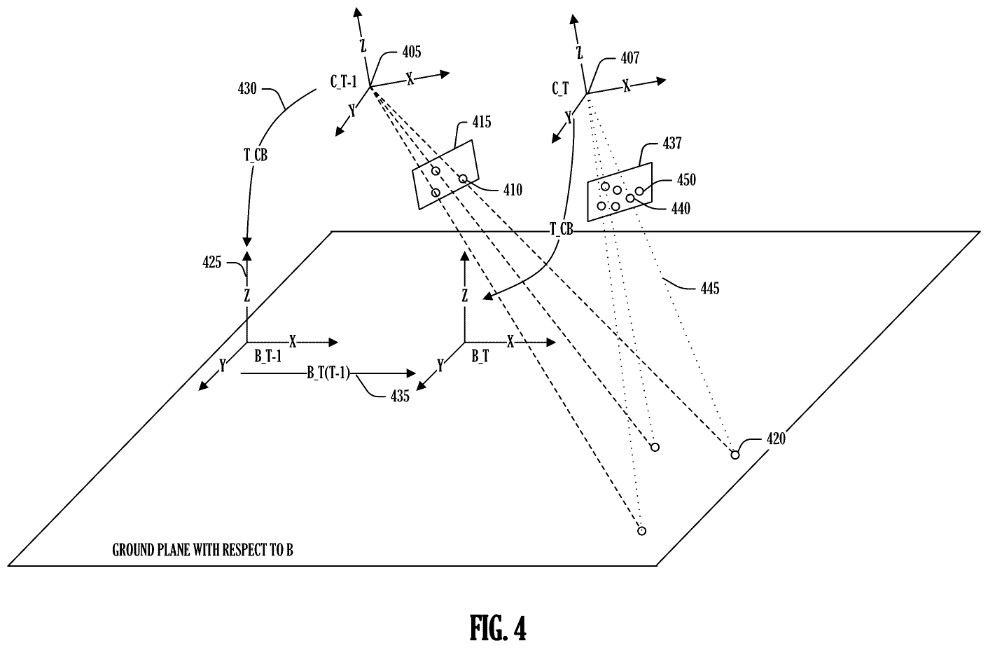

FIG. 4 illustrates an example of correspondence between two two-dimensional images (image 415 and image 437) of an environment, according to an embodiment. After the initial estimate and data collection are taken (e.g., described above with respect to FIG. 3), a “calibration session”, which can be a closed-loop route, can be performed. In an example, in the calibration session, the vehicle moves forward, does a U-turn, and returns back over the same tracks.

In an example, 2D points (e.g., points 410 and points 450) are matched cross-correspondences between t-1 (e.g., frame 405) and t (e.g., frame 407) using ORB feature descriptors. A match between two ORB descriptors is considered successful when the hamming distance between the ORB descriptors is less than a threshold value.

The transformation 435 from t to t-1, or

$${T}_{t - 1}^{t}$$

can be obtained by fusing satellite navigation-such as a global navigation satellite system (GNSS) like the Global Positioning System (GPS), Global Navigation Satellite System (GLONASS), BeiDou, Galileo, or Quasi-Zenith Satellite System—and inertial measurement unit (IMU), or other dead reckoning device, measurements. In each timestep, a localization pipeline can provide a base to world transformation

$${T}_{{B}_{t}}^{W} -$$

the pose of the vehicle (e.g., tractor) with respect to the environment (not illustrated) —that results in

$${T}_{t - 1}^{t} = {T}_{W}^{t} {T}_{t - 1}^{W} = {T}_{t}^{{W}^{- 1}} {T}_{t - 1}^{W} ,$$

where B is omitted for simplicity; which are known for each pair of consecutive timesteps.

After the dataset is collected, an initial estimate of the 3D points 420 is made by assuming that the ground roughly corresponds to the z=0 plane. In an example, the 2D points 410 at t-1 are projected in rays and get the 3D point 420 locations by taking the intersection of the rays with the ground. This can be accomplished with an initial estimate for the C-to-B transformation 430, or

$${T}_{B}^{C} ,$$

to calculate ground plane coefficients with respect to C.

Other assumptions that can be made include assuming a monocular camera with the coordinate frame C. Again, the frame C is related to the vehicle frame, frame B, through the rigid transformation

$${T}_{B}^{C} 425.$$

The frame B moves in time in the 3D space (with the constraint z=0) via the transformation

$${T}_{t - 1}^{t} 435 ,$$

which is the relative motion from t-1 to t. Also, the dataset includes multiple timestep pairs (or TemporalFeatures, each with N features) which may or may not be consecutive.

The already observed features (e.g., points 410) can be denoted as Oₜ₋₁ and oₜ. Because the oₜ₋₁ 2D image points 410 have been constructed in the 3D space (points 420), a projection (e.g., via rays 445) of the points 420 can be made onto the image planes of Cₜ₋₁ 405 and Cₜ 407 (e.g., image 415 and image 437 respectively) as pₜ₋₁ and pₜ (e.g., points 440).

The 3D reconstructed features can be denoted as r with respect to the coordinate frame Bₜ₋₁. The reconstructed features r can be calculated using the initial

$${T}_{C}^{B} ,$$

Oₜ₋₁, and ground equation z=0 as described above. To re-project r in Cₜ₋₁ 405 and Cₜ 407 respectively, the following transformations can be applied sequentially:

$${p}_{t - 1} = [ \begin{matrix}{u}_{t - 1} \\ {v}_{t - 1} \\ 1\end{matrix} ] = {KT}_{B}^{C} r$$

$${p}_{t} = [ \begin{matrix}{u}_{t} \\ {v}_{t} \\ 1\end{matrix} ] = {KT}_{B}^{C} {T}_{t - 1}^{t} r$$

These transformations can be formulated as a minimization problem in accordance with the following:

$${min}_{q} = \frac{1}{2} {\sum }^{N} L ( ‖ {d}_{x}^{t - 1} , {d}_{y}^{t - 1} , {d}_{x}^{t} , {d}_{y}^{t} ‖ )$$

$$where$$

$${d}^{t - 1} = {o}_{t - 1} - {p}_{t - 1}$$

$${d}^{t} = {o}_{t} - {p}_{t}$$

and q contains the: rotational part of T_{C}^{B} 430, and the reconstructions r. N is the total number of correspondences and L (·) a loss function (e.g., Huber-Loss). The refinement operations move to find the camera orientation aspect values that minimize this formula. In an example,

$${T}_{C}^{B}$$

is expressed as rotational aspects roll, pitch, and yaw, as well as translational parameters x, y, and z. In an example, the minimization is performed only and exclusively with respect to pitch, yaw, or both pitch and yaw to reduce computational complexity.

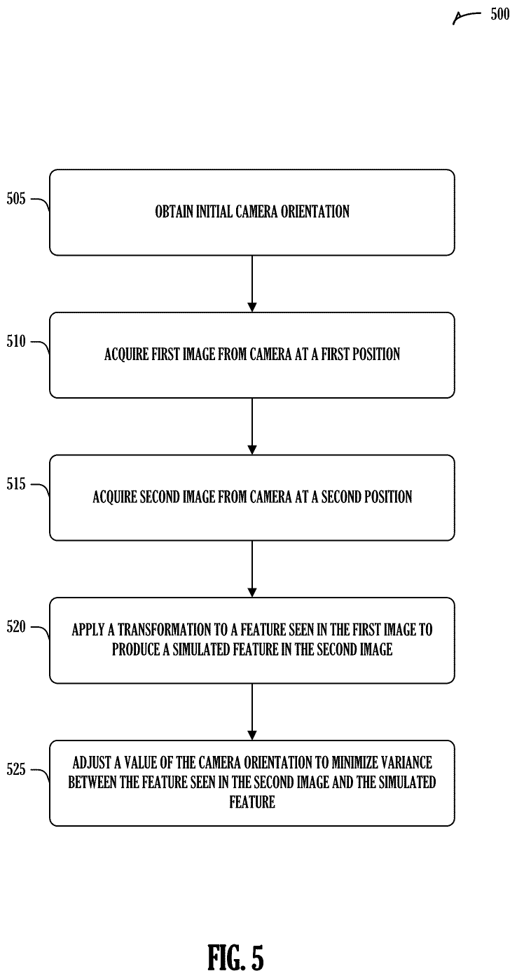

FIG. 5 illustrates a flow diagram of an example of a method 500 for calibrating a camera mounted to a vehicle, according to an embodiment. The operations of the method 500 are performed by computational hardware, such as that described above or below (e.g., processing circuitry).

At operation 505, an initial orientation of the camera with respect to the vehicle is obtained. In an example, the initial orientation is based on a mounting bracket configured to rigidly mount the camera to the vehicle. In an example, the mounting bracket is configured to hold the camera at a seventeen degree downward angle with respect to a surface upon which the vehicle moves.

At operation 510, a first image is obtained from the camera at a first time. The first image includes a feature of an environment.

At operation 515, a second image is obtained from the camera at a second time; the vehicle moving between the first time and the second time. The second image also includes the feature. In an example, the vehicle is moving on a calibration course in which the vehicle progresses in a straight line, turns around, and progress back over the previously traversed path.

At operation 520, a transformation is applied to the feature in the first image to produce a simulated feature in the second image. In an example, the transformation is based on a motion of the vehicle. In an example, the motion of the vehicle is based on a combination of a satellite positioning system and an inertial measurement unit that are both mounted on the vehicle.

In an example, the transformation simulates a ray being projected from the camera at the first time to the feature in the environment and reprojected back to the camera at the second time to produce the simulated feature in the second image.

At operation 525, an aspect of initial orientation of the camera is adjusted to minimize a distance between the simulated feature and the feature in the second image. In an example, the aspect of the initial orientation is limited to pitch or yaw.

In an example, adjusting the aspect of the initial orientation includes finding a local minimum as a version of the aspect. In an example, finding the local minima includes limiting a search of the local minima to plus or minus five degrees from the initial orientation.

In an example, The method 500 can include the following operations applying a second transformation to the feature in the second image to produce a second simulated feature in the first image and adjusting the aspect of the initial orientation of the camera to minimize a distance between the second simulated feature and the feature in the first image.

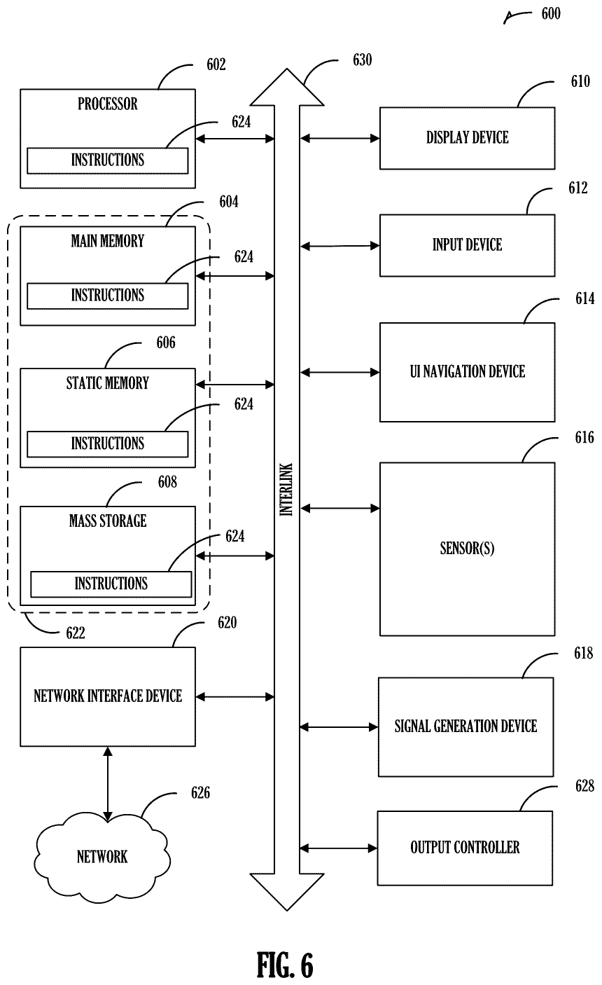

FIG. 6 illustrates a block diagram of an example machine 600 upon which any one or more of the techniques (e.g., methodologies) discussed herein may perform. Examples, as described herein, may include, or may operate by, logic or a number of components, or mechanisms in the machine 600. Circuitry (e.g., processing circuitry) is a collection of circuits implemented in tangible entities of the machine 600 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 600 follow.

In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 600 may include a hardware processor 602 (e.g., a central processing unit (CPU), a graphics processing unit (GPU), a hardware processor core, or any combination thereof), a main memory 604, a static memory (e.g., memory or storage for firmware, microcode, a basic-input-output (BIOS), unified extensible firmware interface (UEFI), etc.) 606, and mass storage 608 (e.g., hard drives, tape drives, flash storage, or other block devices) some or all of which may communicate with each other via an interlink (e.g., bus) 630. The machine 600 may further include a display unit 610, an alphanumeric input device 612 (e.g., a keyboard), and a user interface (UI) navigation device 614 (e.g., a mouse). In an example, the display unit 610, input device 612 and UI navigation device 614 may be a touch screen display. The machine 600 may additionally include a storage device (e.g., drive unit) 608, a signal generation device 618 (e.g., a speaker), a network interface device 620, and one or more sensors 616, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 602, the main memory 604, the static memory 606, or the mass storage 608 may be, or include, a machine readable medium 622 on which is stored one or more sets of data structures or instructions 624 (e.g., software) embodying or utilized by any one or more of the techniques or functions described herein. The instructions 624 may also reside, completely or at least partially, within any of registers of the processor 602, the main memory 604, the static memory 606, or the mass storage 608 during execution thereof by the machine 600. In an example, one or any combination of the hardware processor 602, the main memory 604, the static memory 606, or the mass storage 608 may constitute the machine readable media 622. While the machine readable medium 622 is illustrated as a single medium, the term “machine readable medium” may include a single medium or multiple media (e.g., a centralized or distributed database, and/or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, information stored or otherwise provided on the machine readable medium 622 may be representative of the instructions 624, such as instructions 624 themselves or a format from which the instructions 624 may be derived. This format from which the instructions 624 may be derived may include source code, encoded instructions (e.g., in compressed or encrypted form), packaged instructions (e.g., split into multiple packages), or the like. The information representative of the instructions 624 in the machine readable medium 622 may be processed by processing circuitry into the instructions to implement any of the operations discussed herein. For example, deriving the instructions 624 from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 624.

In an example, the derivation of the instructions 624 may include assembly, compilation, or interpretation of the information (e.g., by the processing circuitry) to create the instructions 624 from some intermediate or preprocessed format provided by the machine readable medium 622. The information, when provided in multiple parts, may be combined, unpacked, and modified to create the instructions 624. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 624 may be further transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 802.11 family of standards known as Wi-Fi®, IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software. A transmission medium is a machine readable medium.

### Additional Notes & Examples

Example 1 is a system for calibrating a camera mounted to a vehicle, the system comprising: a memory including instructions; and processing circuitry that, when in operation, is configured by the instructions to: obtain an initial orientation of the camera with respect to the vehicle, obtain a first image from the camera at a first time, the first image including a feature of an environment; obtain a second image from the camera at a second time, the second image including the feature, the vehicle moving between the first time and the second time; apply a transformation to the feature in the first image to produce a simulated feature in the second image; and adjust an aspect of initial orientation of the camera to minimize a distance between the simulated feature and the feature in the second image.

In Example 2, the subject matter of Example 1, wherein the aspect of the initial orientation is limited to pitch or yaw.

In Example 3, the subject matter of any of Examples 1-2, wherein the transformation is based on a motion of the vehicle.

In Example 4, the subject matter of Example 3, wherein the motion of the vehicle is based on a combination of a satellite positioning system and an inertial measurement unit that are both mounted on the vehicle.

In Example 5, the subject matter of any of Examples 1-4, wherein the transformation simulates a ray being projected from the camera at the first time to the feature in the environment and reflected back to the camera at the second time to produce the simulated feature in the second image.

In Example 6, the subject matter of any of Examples 1-5, wherein, to adjust the aspect of the initial orientation, the processing circuitry is configured to find a local minimum as a version of the aspect.

In Example 7, the subject matter of Example 6, wherein, to find the local minimum, the processing circuitry is configured to limit a search for the local minimum to plus or minus five degrees from the initial orientation.

In Example 8, the subject matter of any of Examples 1-7, wherein the vehicle is moving on a calibration course in which the vehicle progresses in a straight line, turns around, and progress back over the previously traversed path.

In Example 9, the subject matter of any of Examples 1-8, wherein the initial orientation is based on a mounting device configured to rigidly mount the camera to the vehicle.

In Example 10, the subject matter of Example 9, wherein the mounting device is configured to hold the camera at a seventeen degree downward angle with respect to a surface upon which the vehicle moves.

In Example 11, the subject matter of any of Examples 1-10, wherein the processing circuitry is configured to: apply a second transformation to the feature in the second image to produce a second simulated feature in the first image; and adjust the aspect of the initial orientation of the camera to minimize a distance between the second simulated feature and the feature in the first image.

Example 12 is, The system of Example 1, wherein the system includes the camera.

Example 13 is, The system of Example 1, wherein the system includes the mounting device.

Example 14 is a method for calibrating a camera mounted to a vehicle, the method comprising: obtaining an initial orientation of the camera with respect to the vehicle, obtaining a first image from the camera at a first time, the first image including a feature of an environment; obtaining a second image from the camera at a second time, the second image including the feature, the vehicle moving between the first time and the second time; applying a transformation to the feature in the first image to produce a simulated feature in the second image; and adjusting an aspect of initial orientation of the camera to minimize a distance between the simulated feature and the feature in the second image.

In Example 15, the subject matter of Example 14, wherein the aspect of the initial orientation is limited to pitch or yaw.

In Example 16, the subject matter of any of Examples 14-15, wherein the transformation is based on a motion of the vehicle.

In Example 17, the subject matter of Example 16, wherein the motion of the vehicle is based on a combination of a satellite positioning system and an inertial measurement unit that are both mounted on the vehicle.

In Example 18, the subject matter of any of Examples 14-17, wherein the transformation simulates a ray being projected from the camera at the first time to the feature in the environment and reflected back to the camera at the second time to produce the simulated feature in the second image.

In Example 19, the subject matter of any of Examples 14-18, wherein adjusting the aspect of the initial orientation includes finding a local minimum as a version of the aspect.

In Example 20, the subject matter of Example 19, wherein finding the local minimum includes limiting a search for the local minimum to plus or minus five degrees from the initial orientation.

In Example 21, the subject matter of any of Examples 14-20, wherein the vehicle is moving on a calibration course in which the vehicle progresses in a straight line, turns around, and progress back over the previously traversed path.

In Example 22, the subject matter of any of Examples 14-21, wherein the initial orientation is based on a mounting device configured to rigidly mount the camera to the vehicle.

In Example 23, the subject matter of Example 22, wherein the mounting device is configured to hold the camera at a seventeen degree downward angle with respect to a surface upon which the vehicle moves.

In Example 24, the subject matter of any of Examples 14-23 comprising: applying a second transformation to the feature in the second image to produce a second simulated feature in the first image; and adjusting the aspect of the initial orientation of the camera to minimize a distance between the second simulated feature and the feature in the first image.

Example 25 is a machine readable medium including instructions for calibrating a camera mounted to a vehicle, the instructions, when executed by processing circuitry, cause the processing circuitry to performs operations comprising: obtaining an initial orientation of the camera with respect to the vehicle, obtaining a first image from the camera at a first time, the first image including a feature of an environment; obtaining a second image from the camera at a second time, the second image including the feature, the vehicle moving between the first time and the second time; applying a transformation to the feature in the first image to produce a simulated feature in the second image; and adjusting an aspect of initial orientation of the camera to minimize a distance between the simulated feature and the feature in the second image.

In Example 26, the subject matter of Example 25, wherein the aspect of the initial orientation is limited to pitch or yaw.

In Example 27, the subject matter of any of Examples 25-26, wherein the transformation is based on a motion of the vehicle.

In Example 28, the subject matter of Example 27, wherein the motion of the vehicle is based on a combination of a satellite positioning system and an inertial measurement unit that are both mounted on the vehicle.

In Example 29, the subject matter of any of Examples 25-28, wherein the transformation simulates a ray being projected from the camera at the first time to the feature in the environment and reflected back to the camera at the second time to produce the simulated feature in the second image.

In Example 30, the subject matter of any of Examples 25-29, wherein adjusting the aspect of the initial orientation includes finding a local minimum as a version of the aspect.

In Example 31, the subject matter of Example 30, wherein finding the local minimum includes limiting a search for the local minimum to plus or minus five degrees from the initial orientation.

In Example 32, the subject matter of any of Examples 25-31, wherein the vehicle is moving on a calibration course in which the vehicle progresses in a straight line, turns around, and progress back over the previously traversed path.

In Example 33, the subject matter of any of Examples 25-32, wherein the initial orientation is based on a mounting device configured to rigidly mount the camera to the vehicle.

In Example 34, the subject matter of Example 33, wherein the mounting device is configured to hold the camera at a seventeen degree downward angle with respect to a surface upon which the vehicle moves.

In Example 35, the subject matter of any of Examples 25-34 wherein the operations comprise: applying a second transformation to the feature in the second image to produce a second simulated feature in the first image; and adjusting the aspect of the initial orientation of the camera to minimize a distance between the second simulated feature and the feature in the first image.

Example 36 is a system for calibrating a camera mounted to a vehicle, the system comprising: means for obtaining an initial orientation of the camera with respect to the vehicle, means for obtaining a first image from the camera at a first time, the first image including a feature of an environment; means for obtaining a second image from the camera at a second time, the second image including the feature, the vehicle moving between the first time and the second time; means for applying a transformation to the feature in the first image to produce a simulated feature in the second image; and means for adjusting an aspect of initial orientation of the camera to minimize a distance between the simulated feature and the feature in the second image.

In Example 37, the subject matter of Example 36, wherein the aspect of the initial orientation is limited to pitch or yaw.

In Example 38, the subject matter of any of Examples 36-37, wherein the transformation is based on a motion of the vehicle.

In Example 39, the subject matter of Example 38, wherein the motion of the vehicle is based on a combination of a satellite positioning system and an inertial measurement unit that are both mounted on the vehicle.

In Example 40, the subject matter of any of Examples 36-39, wherein the transformation simulates a ray being projected from the camera at the first time to the feature in the environment and reflected back to the camera at the second time to produce the simulated feature in the second image.

In Example 41, the subject matter of any of Examples 36-40, wherein the means for adjusting the aspect of the initial orientation include means for finding a local minimum as a version of the aspect.

In Example 42, the subject matter of Example 41, wherein the means for finding the local minimum include means for limiting a search for the local minimum to plus or minus five degrees from the initial orientation.

In Example 43, the subject matter of any of Examples 36-42, wherein the vehicle is moving on a calibration course in which the vehicle progresses in a straight line, turns around, and progress back over the previously traversed path.

In Example 44, the subject matter of any of Examples 36-43, wherein the initial orientation is based on a mounting device configured to rigidly mount the camera to the vehicle.

In Example 45, the subject matter of Example 44, wherein the mounting device is configured to hold the camera at a seventeen degree downward angle with respect to a surface upon which the vehicle moves.

In Example 46, the subject matter of any of Examples 36-45 comprising: means for applying a second transformation to the feature in the second image to produce a second simulated feature in the first image; and means for adjusting the aspect of the initial orientation of the camera to minimize a distance between the second simulated feature and the feature in the first image.

Example 47 is at least one machine-readable medium including instructions that, when executed by processing circuitry, cause the processing circuitry to perform operations to implement of any of Examples 1-46.

Example 48 is an apparatus comprising means to implement of any of Examples 1-46.

Example 49 is a system to implement of any of Examples 1-46.

Example 50 is a method to implement of any of Examples 1-46.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. A system for calibrating a camera mounted to a vehicle, the system comprising:
a memory including instructions; and
processing circuitry that, when in operation, is configured by the instructions to:
obtain an initial orientation of the camera with respect to the vehicle,
obtain a first image from the camera at a first time, the first image including a feature of an environment;
obtain a second image from the camera at a second time, the second image including the feature, the vehicle moving between the first time and the second time;
apply a transformation to the feature in the first image to produce a simulated feature in the second image; and
adjust an aspect of initial orientation of the camera to minimize a distance between the simulated feature and the feature in the second image.

2. The system of claim 1, wherein the aspect of the initial orientation is limited to pitch or yaw.

3. The system of claim 1, wherein the transformation is based on a motion of the vehicle.

4. The system of claim 3, wherein the motion of the vehicle is based on a combination of a satellite positioning system and an inertial measurement unit that are both mounted on the vehicle.

5. The system of claim 1, wherein the transformation simulates a ray being projected from the camera at the first time to the feature in the environment and reflected back to the camera at the second time to produce the simulated feature in the second image.

6. The system of claim 1, wherein, to adjust the aspect of the initial orientation, the processing circuitry is configured to find a local minimum as a version of the aspect.

7. The system of claim 6, wherein, to find the local minimum, the processing circuitry is configured to limit a search for the local minimum to plus or minus five degrees from the initial orientation.

8. The system of claim 1, wherein the vehicle is moving on a calibration course in which the vehicle progresses in a straight line, turns around, and progress back over the previously traversed path.

9. The system of claim 1, wherein the initial orientation is based on a mounting device configured to rigidly mount the camera to the vehicle.

10. The system of claim 9, wherein the mounting device is configured to hold the camera at a seventeen degree downward angle with respect to a surface upon which the vehicle moves.

11. The system of claim 1, wherein the processing circuitry is configured to:
apply a second transformation to the feature in the second image to produce a second simulated feature in the first image; and
adjust the aspect of the initial orientation of the camera to minimize a distance between the second simulated feature and the feature in the first image.

12. The system of claim 1, wherein the system includes the camera.

13. The system of claim 1, wherein the system includes the mounting device.

14. A method for calibrating a camera mounted to a vehicle, the method comprising:
obtaining an initial orientation of the camera with respect to the vehicle,
obtaining a first image from the camera at a first time, the first image including a feature of an environment;
obtaining a second image from the camera at a second time, the second image including the feature, the vehicle moving between the first time and the second time;
applying a transformation to the feature in the first image to produce a simulated feature in the second image; and
adjusting an aspect of initial orientation of the camera to minimize a distance between the simulated feature and the feature in the second image.

15. The method of claim 14, wherein the transformation simulates a ray being projected from the camera at the first time to the feature in the environment and reflected back to the camera at the second time to produce the simulated feature in the second image.

16. The method of claim 14 comprising:
applying a second transformation to the feature in the second image to produce a second simulated feature in the first image; and
adjusting the aspect of the initial orientation of the camera to minimize a distance between the second simulated feature and the feature in the first image.

17. A machine readable medium including instructions for calibrating a camera mounted to a vehicle, the instructions, when executed by processing circuitry, cause the processing circuitry to performs operations comprising:
obtaining an initial orientation of the camera with respect to the vehicle,
obtaining a first image from the camera at a first time, the first image including a feature of an environment;
obtaining a second image from the camera at a second time, the second image including the feature, the vehicle moving between the first time and the second time;
applying a transformation to the feature in the first image to produce a simulated feature in the second image; and
adjusting an aspect of initial orientation of the camera to minimize a distance between the simulated feature and the feature in the second image.

18. The machine readable medium of claim 17, wherein the transformation simulates a ray being projected from the camera at the first time to the feature in the environment and reflected back to the camera at the second time to produce the simulated feature in the second image.

19. The machine readable medium of claim 17, wherein adjusting the aspect of the initial orientation includes finding a local minimum as a version of the aspect.

20. The machine readable medium of claim 17 wherein the operations comprise:
applying a second transformation to the feature in the second image to produce a second simulated feature in the first image; and
adjusting the aspect of the initial orientation of the camera to minimize a distance between the second simulated feature and the feature in the first image.
